(19) United States
(12) Patent Application Publication
(10) Pub. No.: US 2014/0372270 A1
(43) Pub. Date: Dec. 18, 2014

(54) System and Method for Balance Requests

(71) Applicants: Vitali Strasser, Hadamar (DE); Stymir Saevarsson, Niederzeuzheim (DE); Tom Grünheit, Wiesbaden (DE)

(72) Inventors: Vitali Strasser, Hadamar (DE); Stymir Saevarsson, Niederzeuzheim (DE); Tom Grünheit, Wiesbaden (DE)

(73) Assignee: PEACHES Mobile GmbH, Wiesbaden (DE)

(21) Appl. No.: 14/472,079

(22) Filed: Aug. 28, 2014

Related U.S. Application Data
(63) Continuation of application No. PCT/EP2013/072708, filed on Oct. 30, 2013.

(30) Foreign Application Priority Data
Oct. 31, 2012 (DE) 102012021318.2

(51) Int. Cl. G06Q 40/02; H04L 29/08

(52) U.S. Cl. CPC G06Q 40/02; H04L 67/02
USPC 705/35

(57) ABSTRACT

The invention relates inter alia to a computer program (134) which is configured to implement a web service and which has an interface (137) via which a program component (135) is callable. The program component (135) is configured to cause transmission of information relating to a balance available to a user of a telecommunications terminal (110) by a server.

### CROSS-REFERENCE TO RELATED PATENT APPLICATIONS

This patent application is a continuation of PCT/EP2013/072708, filed Oct. 30, 2013, which claims priority to German Application No. 10 2012 021 318.2, filed Oct. 31, 2012, the entire teachings and disclosure of which are incorporated herein by reference thereto.

### FIELD OF THE INVENTION

The invention relates to the request for information relating to a balance available to a user of a telecommunications terminal.

### BACKGROUND OF THE INVENTION

Chargeable services can be used by means of a telecommunications terminal. These services may be for example a communications service such as telephone calls or also non-cash benefits which may be purchased by means of the telecommunication terminal. Various possibilities exist for paying the costs that result from this. A distinction is made in this connection between types of payment, where a corresponding payment must have already been made before a service is used (prepaid) and types of payment where payment only has to be made after the service has been used (postpaid).

With prepaid payment a balance is conventionally purchased before the respective service is used. In many cases the balance purchased is not identical to the costs of the service which is being used. By way of example, a certain balance is purchased before telecommunication services, for example telephone services, are used by means of a mobile phone. This balance is often not used up by a single phone call. Since a user of the telephone service provider does not usually precisely survey or really note the resulting costs it is frequently unclear to the user how much his remaining current balance is. Even without a service having been used after a balance has been purchased there may be uncertainty in relation to the remaining balance purely due to the balance having been purchased a long time ago.

Against this background it is necessary to provide users of telecommunications terminals with the possibility of being able to find out about their current balance in order to use chargeable services.

### SUMMARY OF THE INVENTION

According to one known technical solution a user of a telecommunications terminal, who wants to find out about his balance, inputs a command into his telecommunications terminal. This command can be by way of example an Unstructured Supplementary Service Data (USSD) command. The USSD command can be sent via a telecommunications network to a server configured to process the command and can be processed therein. The balance can be ascertained by the server and balance information can be transmitted back to the telecommunications terminal. The balance can then be displayed there.

This solution is not practicable in all cases however. The use of USSD commands is not always possible because either the telecommunications terminal does not allow transmission of a USSD command, for example due to its software configuration, and/or does not allow a server's response to the USSD message to be displayed. In addition, some providers do not allow for chargeable services, which can be used by means of a telecommunications terminal, to react to a USSD command with the transmission of balance information, by way of example because they do not supply an appropriate server. In such cases frequently the only option available to the user is to acquire balance information by making a call to the provider, or to retrieve this information by way of an Internet platform. Many users regard this as inconvenient. In both cases the balance information cannot be readily transferred to software applications.

It is an object of the present invention to facilitate the request for information relating to a balance available to a user of a telecommunications terminal.

According to a first aspect of the invention this object is achieved by a computer program which is configured to implement a web service and which has an interface via which a program component can be called, wherein the program component is configured to cause transmission of information relating to a balance available to a user of a telecommunications terminal by a server.

According to a second aspect of the invention this object is achieved by a method comprising causing of transmission of information relating to a balance available to a user of a telecommunications terminal by a server, wherein the causing occurs by a program component of a computer program, wherein the computer program is configured to implement a web service, and the computer program has an interface via which the program component is callable.

The method according to the second aspect of the invention can be implemented by way of example by:

A computer program which comprises program code for carrying out the method if the program code is run on a processor. The computer program can be stored on a computer-readable medium.

A apparatus which comprises means for carrying out the method or is configured to carry out the method.

A apparatus comprising means for implementing a web service and for causing transmission of information relating to a balance available to a user of a telecommunications terminal by a server by a program component of a computer program which is configured to implement a web service and which has an interface via which the program component is callable.

An apparatus comprising at least one processor and at least one memory, which contains computer program code, wherein the at least one memory and the computer program code are configured, together with the at least one processor, to cause an apparatus to carry out the method according to the second aspect of the invention.

An apparatus comprising at least one processor and at least one memory, which contains computer program code, wherein the at least one memory and the computer program code are configured, together with the at least one processor, to cause a apparatus to run a computer program which is configured to implement a web service, and which has an interface via which a program component is callable, wherein the program component is configured to cause transmission of information relating to a balance available to a user of a telecommunications terminal by a server.

According to a third aspect of the invention this object is achieved by a computer program which is configured to call, via an interface of a computer program according to the first aspect of the invention, the program component of the computer program according to the first aspect of the invention.

According to a fourth aspect of the invention this object is achieved by a method comprising calling a program component of a computer program, wherein the program component is configured to implement a web service via an interface of the computer program, wherein the program component is configured to cause transmission of information relating to a balance available to a user of a telecommunications terminal by a server.

The method according to the fourth aspect of the invention can be achieved for example by:

A computer program which comprises program code for carrying out the method if the program code is executed on a processor. The computer program can be stored on a computer-readable medium.

An apparatus which includes means for carrying out the method or is configured to carry out the method.

An apparatus comprising means for calling a program component of a computer program, which is configured to implement a web service, via an interface of a computer program. The program component is configured to cause transmission of information relating to a balance available to a user of a telecommunications terminal by a server.

An apparatus comprising at least one processor and at least one memory, which contains computer program code, wherein the at least one memory and the computer program code are configured, together with the at least one processor, to cause an apparatus to carry out the method according to the fourth aspect of the invention.

An apparatus comprising at least one processor and at least one memory, which contains computer program code, wherein the at least one memory and the computer program code are configured, together with the at least one processor, to cause an apparatus to call a program component of a computer program via an interface of the computer program, wherein the program component is configured to implement a web service, wherein the program component is configured to cause transmission of information relating to a balance available to a user of a telecommunications terminal by a server.

According to a fifth aspect of the invention this object is achieved by an apparatus, in particular a server, on which a computer program according to the first aspect of the invention runs.

According to a sixth aspect of the invention this object is achieved by an apparatus on which a computer program according to the third aspect of the invention runs.

According to a seventh aspect of the invention this object is achieved by a system comprising an apparatus according to the fifth aspect of the invention and an apparatus according to the sixth aspect of the invention.

For the sake of clarity the invention will primarily be explained below with respect to the computer program according to the first aspect of the invention. The statements logically relate, however, to the second to seventh aspects of the invention as well.

As the computer program according to the invention implements a web service, a possibility of addressing the interface of the computer program remotely, in particular via the Internet, is created. The program component can be called therefore. Transmission of information relating to a balance available to a user of a telecommunications network, hereinafter always called balance information, can be caused in this way by a server. The balance information can be supplied to other computer programs and be processed by them. Recourse to USSD commands for example is not necessary, so that balance information can also be acquired if this is not possible by means of one or more USSD command(s). In addition the user can at the same time be saved from having to acquire balance information by making a call to a provider which has the balance or from having to retrieve balance information via an Internet platform.

The computer program according to the first aspect of the invention can be loaded in a memory, for example a memory with random access (random access memory, RAM) and comprise program code to implement a web service if the program code is executed on a processor. Furthermore, it may comprise a program component which comprises program code to cause transmission of information relating to a balance available to a user of a telecommunications terminal by a server if the program code is executed on a processor. The computer program can also include program code for implementing an interface if the program code is executed on a processor. The program component is callable via the interface.

The computer program according to the third aspect of the invention can be loaded in a memory, for example a RAM, and contain program code for calling a program component of a computer program, which is configured to implement a web service, via an interface of the computer program if the program code is executed on a processor. The program component is configured to cause transmission of information relating to a balance available to a user of a telecommunications terminal by a server. In other words, the computer program according to the third aspect of the invention can comprise program code for calling the program component of the computer program according to the first aspect of the invention if the program code is executed on a processor.

The computer programs according to the first or third aspect of the invention can be distributed by way of example via a network such as the Internet, a telephone or mobile phone network and/or a local network. The computer programs can be at least partially software and/or firmware of a processor.

The computer programs according to the invention can be stored by way of example on a computer-readable storage medium, for example a magnetic, electric, electro-magnetic, optical and/or other type of storage medium. The storage medium may for example be part of a processor, by way of example a (non-volatile or volatile) program memory of the processor or a part thereof.

In this specification a processor is taken to mean inter alia control units, microprocessors, micro-control units such as microcontrollers, digital signal processors (DSP), Application Specific Integrated Circuits (ASICs) or Field Programmable Gate Arrays (FPGAs).

Web service is an alternative name for web service. A web service can be taken to mean a service which enables the interaction between at least two computer programs (different from the computer program which implements the web service). The interaction can occur without the assistance of a human user, i.e. automatically. The at least two computer programs and the web service can run in particular on spatially separate platforms, i.e. platforms remote from each other. The computer program, which is configured to implement the web service, runs on a platform different from the telecommunications terminal. The interaction can in particular comprise the exchange of data between the at least two computer programs with the aid of the web service. One of the at least two computer programs can likewise call a program routine of the other computer program of the at least two computer programs by means of the web service, for example in that firstly the web service is called, and this in turn then effects calling of the program routine. A computer program which makes a service request of the web service can be called a client program while a computer program which provides a service at the causing of the web service can be called a server program. For example, the computer program according to the third aspect of the invention can be regarded as a client program.

The web service can communicate with the at least two computer programs by exchanging messages. Messages can be exchanged in particular by means of Internet-based protocols. These protocols can be based for example on the Hypertext Transfer Protocol (HTTP), the Hypertext Transfer Protocol Secure (HTTPS), the File Transfer Protocol (FTP), the Simple Mail Transfer Protocol (SMTP), the Transmission Control Protocol (TCP) and/or the Internet Protocol (IP) to name just a few examples.

The program component of the computer program according to the invention can for example implement a function, a procedure or a method of the computer program. The program component can include program code to cause transmission of information relating to a balance available to a user of a telecommunications terminal by a server if the computer program is loaded in a memory and if the program code is executed on a processor.

The interface of the computer program can render the program component of the computer program accessible to other computer programs. The interface can be an Application Programming Interface (API), in particular a web API which is addressable via an Internet-based protocol. Over The interface can include a description of which parameter(s) (compulsory or optional) are to be transferred—possibly together with a specification of the associated types of data—so that the program component can fulfil its intended function. It can, moreover, also specify one or more return parameter(s) with or without the associated types of data or data structures. A unique address, for example a Uniform Resource Identifier (URI), in particular a Uniform Resource Locator (URL), can be allocated to the interface to make the web service purposefully addressable.

According to the invention the telecommunications terminal can be any telecommunications terminal by means of which a chargeable service is useable. The telecommunications terminal can in particular be a telecommunications terminal which is configured for bidirectional communication, i.e. which enables both transmission and receiving of information. The telecommunications terminal can be by way of example a telephone terminal which allows use of telephone services. The telecommunications terminal can be by way of example a mobile telephone terminal. The telecommunications terminal can therefore be a mobile phone and in particular a smartphone.

The telecommunications terminal can also be a device other than a telephone terminal, however. Further examples of telecommunications terminal include inter alia PCs (Personal Computer), tablet PCs, and other types of portable PCs (notebooks/laptops), Personal Digital Assistant (PDA), games consoles, set-top boxes, etc. which have telecommunications functions. The telecommunications functions can be implemented by way of example in that a wireless or wired connection to a network, and in particular also a connection to the Internet, can be established by means of the telecommunications terminal.

The balance can be an indicator of whether and/or to what extent, for example how often or for how long, and/or what type of chargeable service can be used by means of the telecommunications terminal. The balance can be given in particular as balance in a conventional currency, for example euros or US dollars, etc. It may, however, also be a balance which is given in a different form. By way of example it may be given in the form of a notional currency, for example in the form of points. The balance can have been created by a payment made in advance to purchase the balance (prepaid).

The balance can be available to the user by way of example in that it is personally allocated to him. Alternatively the balance can also be available to the user by way of example in that it is allocated to the telecommunications terminal and the user has access to the telecommunications terminal, so that he can use a chargeable service by means of the telecommunications terminal.

Information relating to a balance available to a user of the telecommunications terminal (balance information) can in particular include or consist of the balance amount. The balance information can, however, in addition or alternatively also relate to other aspects which are connected to the balance available to the user. By way of example such balance information can comprise an expiry date on which the balance completely or partially expires, the date a balance was last purchased or a difference between a maximum possible balance amount and the actual current balance amount.

The server can be supplied by a provider which makes a chargeable service available, for the use of which by means of the telecommunications terminal the balance is useable. The server can be supplied by way of example by a Mobile Network Operator (MNO). The server may also be provided by a Mobile Network Virtual Operator (MNVO) which does not have its own network infrastructure but is based on the network infrastructure of an MNO. The server may also be supplied by a provider (Mobile Virtual Network Enabler, MVNE) which makes the infrastructure of an MNO available as a service for the MVNOs. The server can comprise at least one processor and at least one memory. The server can comprise by way of example a RAM in which program code from a second memory, for example a hard drive, is loaded, and this code can be executed on the at least one processor, so that the server can discern the tasks assigned to it.

Causing transmission of balance information can be caused for example in that the program component accesses the server whereupon this causes transmission of the balance information. Access to the server can comprise sending a message to the server. For this purpose the program component can be configured to generate a suitable message and use corresponding hardware resources of a apparatus, on which the computer program according to the invention is running, such that these take over the physical message transmission to the server. A request for balance information can be encoded in the message.

The message can be transmitted from a apparatus, which provides the hardware resources on which the program component runs, to the server wirelessly or in a wired manner. The transmission path can also contain sections that operate in a wired manner or wirelessly. Protocols from the Internet protocol family, for example TCP and IP, can be used in the transmission. Other protocols may likewise be used.

The balance information can also be transmitted in the form of a message. The transmission may take place wirelessly or in a wired manner in this case as well. The transmission path can likewise contain sections that operate both in a wired manner and wirelessly. Protocols from the Internet protocol family, for example TCP and IP, can be used in the transmission. Provided the apparatus to which the balance information is to be transmitted supports it, the transmission can, however, also occur by way of example by means of an SMS service (SMS=Short Message Service) to mention just one other example.

The transmission path can comprise a plurality of servers. For example, one server of the transmission path can have direct access to the balance information. Another server of the transmission path, for example a server on which the computer program according to the first aspect of the invention—and therefore the program component—runs, can obtain the balance information form the first server and pass it to its destination. In this case both servers can be taken to mean servers which have been caused to transmit balance information.

According to one embodiment the web service is based on the Web Services Description Language (WSDL) and SOAP. The fact that the web service is based on WSDL can mean that a description of the web service compliant with WSDL exists, which comprises in particular a WSDL description of the interface of the computer program. The fact that the web service is based on SOAP can mean that the exchange of information between a client program and the web service and/or between the client program and the server and/or optionally also an exchange of information between the server and the web service take place on the basis of SOAP.

According to one embodiment the web service is based on Representational State Transfer (REST). The fact that the web service is based on REST can mean that the web service is configured so as to be compliant with REST. This includes in particular that the interface of the computer program is configured so as to be compliant with REST.

According to one embodiment the information relating to a balance available to the user of the telecommunications terminal is transmitted to an apparatus from which a calling of the program component has been issued via the interface.

In this way the balance information is made available to the apparatus, or a computer program running on this apparatus, which requested the balance information by the calling of the program component via the interface. The balance information can be transmitted directly from the server to the apparatus making the request in this connection. Transmission can also occur indirectly to the apparatus making the request. By way of example the balance information can firstly be from the server to an apparatus on which the computer program implementing the web service is running. The balance information can then be forwarded from this apparatus to the apparatus making the request.

The apparatus from which the calling of the program component via the interface—and therefore the request for balance information—has been issued can be a telecommunications terminal by way of example. It may, however, also be a apparatus other than a telecommunications terminal.

According to one embodiment access data is transferable via the interface of the computer program to the program component.

It may therefore be possible that there can be a cause to transmit balance information from the server only when suitable access data is transferred.

The program component can be configured to transmit the access data to the server. For this purpose the program component can include corresponding program code. The program component can be configured to transmit the access data to the server in a message, by means of which the server is at the same time caused to transmit the balance information.

The server can be configured to check the access data and to carry out transmission of the balance information only once the check has been successfully concluded.

The access data can by way of example include a user identification. In the case of a balance that can be used for the chargeable use of telephone services, the user identification can comprise by way of example a unique calling number (Mobile Subscriber Integrated Services Digital Network Number, MSISDN) via which the telecommunications terminal of the user, for example a mobile phone, can be reached. The user identification can also or alternatively comprise a user name. The access data can also comprise a password. The password can be allocated to the user. For this purpose there can be an association between user identification and password, so both the user identification and the corresponding password have to be transferred via the interface as part of the access data in order to be able to cause transmission of the balance information.

According to one embodiment the program component is configured to store the access data only transiently.

It can therefore be achieved that, after transmission of the access data to the server by the program component, no copy of the access data remains in the program component. The web service implemented by the computer program can therefore be used without data protection or security concerns.

That the access data is stored only transiently can in particular mean that it is not permanently stored. This includes the access data being only briefly stored by the program component, only after transfer to the program component via the interface, and being deleted as soon as the access data has been transmitted to the server.

According to one embodiment transmission of the information relating to a balance available to the user of the telecommunications terminal is causable via a website.

That the transmission of the balance information may also be caused via a website means that, in addition to the possibility of causing transmission of the balance information via the program component, causing of transmission of balance information is also possible via the website.

The website can comprise a user interface, so that a human user can cause transmission of the balance information by interaction with the user interface. The user interface can include an input field or a plurality of input fields for access data.

After inputting the access data, the access data can be checked. On successful checking a logon or login can be carried out and access to a protected area of the website permitted. Once this has happened the balance information can be completely or partially displayed on an apparatus, from which a calling of the website took place, i.e. the balance information are transmitted to this apparatus.

The website can be supplied by a provider which makes a chargeable service available, for the use of which by means of the telecommunications terminal the balance can be used.

According to one embodiment the program component is configured to access the website in order to cause transmission of the information.

According to this embodiment it is possible to use the website to cause transmission of the balance information by the program component—and therewith by the web service. The website as an existing resource for the balance request can therefore be used by the web service, and this can be especially efficient. At the same time direct interaction of the user with the website, for example a targeted calling of the website, can be prevented, i.e. access to the website, and therefore the balance information, can be automated.

To be able to access the website the program component can comprise program code which, when executed, provides access to the website.

Access to the website can in particular comprise the program component, for example by generating and transferring a corresponding message, causes a calling of the website. Access can optionally include access data being suitably transferred to the website. This can replace manual inputting of the access data. The program component can be configured to extract balance information displayed by the website following successful login. The program component can be configured to cause transmission of the extracted balance information. Transmission can occur for example to an apparatus from which a calling of the program component has been issued via the interface.

According to one embodiment the balance is useable for utilising a chargeable service of a provider by means of the telecommunications terminal.

The provider can for example be a telecommunications service provider (provider) which in the case by way of example of a mobile phone as the telecommunications terminal offers inter alia phone call services, SMS services (SMS=Short Message Service) and data links, including those which operate in a packet-switched manner, subject to a charge.

According to one embodiment the program component is configured to cause the transmission of information relating to a balance available to the user of the telecommunications terminal by the server in a manner tailored to the provider.

The measures necessary for causing the transmission of balance information can be different depending on the provider. For example, servers responsible for the transmission of balance information can be configured differently. If the program component is configured to cause the transmission of balance information in a manner tailored to the provider it can be ensured that the transmission of balance information can nevertheless be caused.

To configure the program component to cause the transmission of balance information by the server to the telecommunications terminal in a manner tailored to the provider the program component can comprise program code which can cause causing of the server, tailored to the provider, if the program code is executed. The configuration of the program component can in particular comprise a message, which is sent to the server to cause the transmission of balance information and is caused by the program component, being tailored to the provider or its server configuration. It may be that different messages have to be received in the case of servers belonging to different providers so there is transmission of balance information, or that the message has to be purposefully addressed to the server of the respective provider so the balance information may be obtained. Tailoring of the message means that the message reaches the server, the server can process the message and the server can react to it as desired. The websites of different providers can likewise be designed differently, so that access to them has be carried out in an appropriate manner in order to be able to obtain balance information.

Tailoring of the causing of transmission of balance information to the provider can in particular comprise that the access data demanded by the provider is used.

According to one embodiment a further program component of the computer program is callable via a further interface of the computer program, wherein the further program component is configured to cause the transmission of provider information relating to providers which allow transmission of information relating to a balance available to a user of a telecommunications terminal by a server at the causing of the program component.

Knowledge about the providers can be acquired in this way by the calling of the further program component via the further interface. This knowledge allows balance information to be acquired in the manner described above.

The required configuration of the further program component can be implemented in that the further program component comprises program code which when executed is capable of causing the transmission of provider information relating to providers which allow transmission of balance information by a server at the causing of the above-described program component.

The above statements relating to the interface of the computer program apply to the further interface accordingly. Access data can optionally be transferred to the further program component via the further interface. The further program component can in this case also be configured to store the access data only transiently, as has already been explained above. It may be provided that transmission of the provider information is only caused when the access data is transferred to the further interface. The access data may optionally be checked.

The providers, to which the provider information relates, are here also taken to mean providers which make chargeable services available which are useable with the balance available to the user of the telecommunications terminal.

The provider information can comprise for example a list of providers which support the balance request by the program component in the manner described above. Alternatively or additionally it may contain information that comprises access rules which have to be satisfied to be able to successfully cause transmission of balance information by the server. The access rules can regulate by way of example whether and optionally which access data is required to be able to successfully initiate the transmission of the balance information. Types of data can be specified for the access data. It may also be indicated in the access rules by way of example whether registration with the respective provider is required before the transmission of balance information can be caused by the server. In such a case it may be indicated under which address, for example under which URL, such registration is possible.

The provider information can also comprise status information with respect to the current availability of the transmission of balance information in relation to the respective provider to mention just one further example of possible information comprised of the provider information.

According to one embodiment an identification module is allocated to the telecommunications terminal.

The allocation of the identification module to the telecommunications terminal can consist by way of example in the identification module being permanently integrated in the telecommunications terminal, being removably arranged in the telecommunications terminal or even being potentially detachably, and optionally also re-connectably, connected to the telecommunications terminal.

The identification module can be any module which allows the telecommunications terminal itself and/or a user of the telecommunications terminal to be identified. To enable identification of the telecommunications terminal itself and/or a user of the telecommunications terminal it may be sufficient if a corresponding identifier is stored in the identification module which can be read from the identification module. One example of an identification module is a SIM card (SIM=Subscriber Identity Module). The term “SIM card” includes different embodiments of SIM cards here. These include mini SIM cards, micro SIM cards and nano SIM cards by way of example.

According to one embodiment the identification module is associated with a provider which provides a chargeable service, for the use of which by means of the telecommunications terminal the balance is useable.

The respective provider may be ascertained by means of the identification module. For this purpose the computer program, for example the program component or the further program component, can be configured to access the identification module to ascertain the provider associated with the identification module. Once the provider has been ascertained in this way, transmission of the information can be caused in a manner tailored to the provider—if this is required.

It may however additionally or alternatively be provided that the provider is ascertained or determined in some other way. This may occur by way of example by a user specification, in particular a user input.

According to one embodiment the server is configured to log an access.

Data about server use can be collated by logging instances of access to the server. This data can be used to levy a user fee.

Logging can include recording data that relates to server use. This data can include for example the number of uses of the server. The data recorded during the course of logging can also include access data transferred during calling of the interface. This data can be forwarded for this purpose to the server, so for its use the operator of the server, for example a provider of a chargeable service for using of which the balance available to the user of the telecommunications terminal is useable, receives required information to charge the user for use of the server.

### BRIEF DESCRIPTION OF THE DRAWINGS

The invention will be explained hereinafter with reference to four figures, in which:

FIG. 1 shows a schematic diagram of an example of an environment in which the invention can be used and which comprises inter alia a telecommunications terminal, a PC and a server on which an embodiment of a computer program according to the first aspect of the invention runs;

FIG. 2 shows a schematic diagram of the server from FIG. 1 on which an embodiment of a computer program according to the first aspect of the invention runs;

FIG. 3 shows a schematic diagram of the telecommunications terminal from FIG. 1 on which a computer program according to the third aspect of the invention can run;

FIG. 4 shows a schematic flow diagram which illustrates an embodiment of an inventive method according to the second aspect of the invention and an embodiment of an inventive method according to the fourth aspect of the invention in the context of the environment illustrated in FIG. 1.

### DETAILED DESCRIPTION OF THE INVENTION

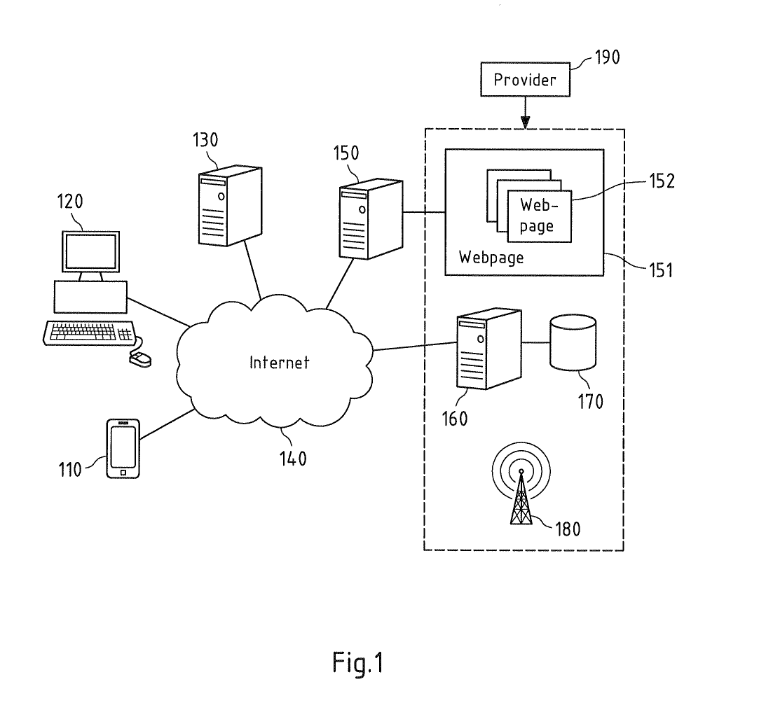

FIG. 1 shows a schematic diagram of an example of an environment in which the present invention can be used. FIG. 1 depicts inter alia a telecommunications terminal 110. The telecommunications terminal 110 is a telephone terminal, more precisely a mobile phone, and specifically a smartphone. A PC 120 is also provided. The scenario described with reference to FIG. 1 also includes a server 130. The smartphone 110, PC 120 and server 130 can each establish a connection to the internet 140. The smartphone 110 and the PC 120 can therefore communicate with the server 130 via the Internet. A web server 150 is also connected to the Internet 140. The web server hosts a website 151 which is constructed from a plurality of web pages 152. A further server 160, which can access a database 170, is connected to the Internet 140. Finally, the antenna 180 in FIG. 1 symbolises the network infrastructure of a mobile phone network. The mobile phone network 180, website 151 and server 160 and the database 170 are provided by a mobile phone service provider (provider) 190. A user of the smartphone 110 can use chargeable telecommunications services offered by the provider 190 using the smartphone 110. These include telephone services, in particular phone call services, but also SMS services and data services that operate in a packet-switched manner.

The smartphone 110 is one embodiment of a apparatus according to the fifth aspect of the invention. The server 130 is an embodiment according to the sixth aspect of the invention. Together smartphone 110 and server 130 form an embodiment of a system according to the seventh aspect of the invention.

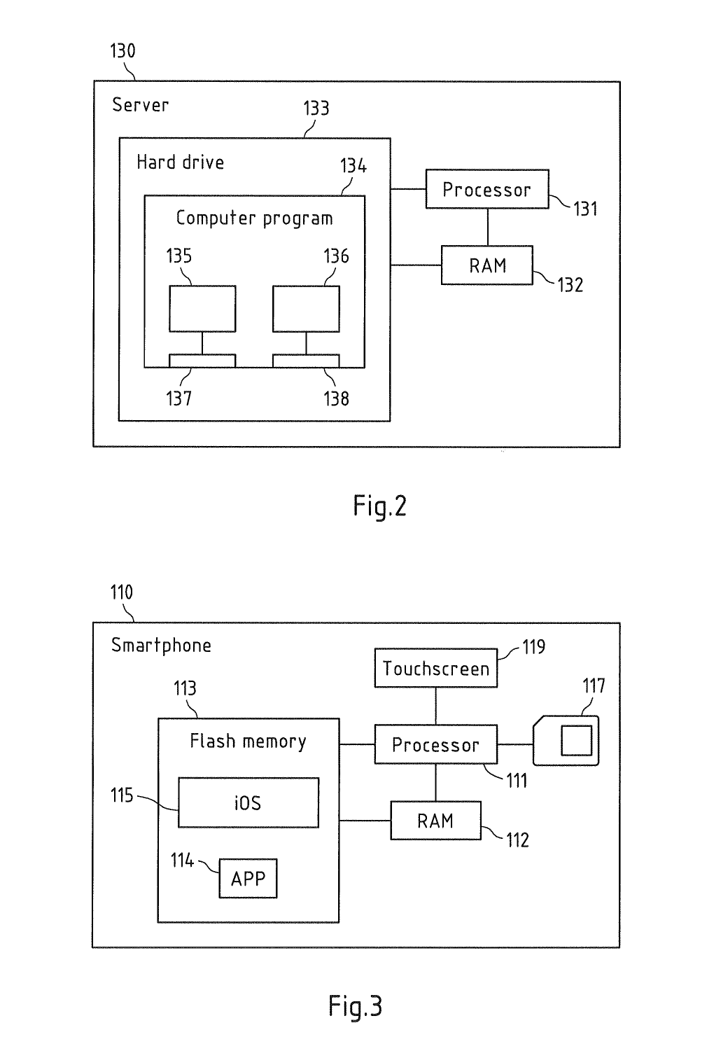

FIG. 2 shows a schematic diagram of the server 130 from FIG. 1 on which an embodiment of a computer program 134 according to the first aspect of the invention runs.

The server 130 comprises inter alia a processor 131, a RAM 132 and a hard drive 133. The processor 131 is connected to the RAM 132 and hard drive 133. There is also a connection between RAM 132 and hard drive 133 via which data from the hard drive 133 can be transferred to the RAM 132.

The computer program 134 is stored on the hard drive 133. The computer program 134 comprises a first program component 135 and a second program component 136. The computer program 134 also comprises a first interface 137 and a second interface 138. The program component 135 is callable via the interface 137 and the program component 136 is callable via the interface 138.

The computer program 134 can be loaded from the hard drive 133 into the RAM 132. It comprises inter alia program code which is configured to implement a web service if the program code is executed on the processor 131. The program component 135 comprises program code which is configured to cause transmission of information relating to a balance available to a user of a telecommunications terminal by a server if the code is executed on the processor 131. The program component 136 comprises program code which is configured to cause the transmission of provider information relating to providers which allow transmission of information relating to a balance available to a user of a telecommunications terminal at the causing of the program component 134 if the code is executed on the processor 131.

FIG. 3 shows a schematic diagram of the smartphone 110 from FIG. 1 on which a computer program 114 according to the third aspect of the invention can run.

The smartphone 110 comprises inter alia a processor 111, a RAM 112 and a flash memory 113. The smartphone 110 is also equipped with a touch-sensitive screen (touchscreen) 119. A SIM card 117 is also inserted in the smartphone 110. The processor 111 is connected to the RAM 112 and the flash memory 113. There is also a connection between RAM 112 and flash memory 113 via which data can be transferred from the flash memory 113 into the RAM 112. The processor 111 is also connected to the SIM card 117, so that it can access the SIM card 117. It is also connected to the touchscreen 119, so that it can control it.

The operating system Apple iOS 115 is stored in the flash memory 113. The operating system 115 can be loaded from the flash memory 113 into the RAM 112 and its program code can be executed on the processor 111.

The computer program 114 is also stored in the flash memory 113. It is in the form of an app, as applications which are provided on a smartphone or tablet PC are frequently called. The app 114 can have arrived in the flash memory 113 by having been downloaded from the Internet by a user of the smartphone 110.

The app 114 can be loaded from the flash memory 113 into the RAM 102. It comprises inter alia program code for calling of the program component 135 of the computer program 134 shown in FIG. 2 via the interface 137 of the computer program 134 if the program code is executed on the processor 111. The app 114 also comprises program code for calling of the program component 136 of the computer program 134 shown in FIG. 2 via the interface 138 of the computer program 134 if the program code is executed on the processor 111.

The SIM card 117 is associated with the provider 190. Linked to the SIM card 117 is a balance which can be utilised for using chargeable services of the provider 190, for example phone call services, SMS services and data links. This balance is therefore available to a user of the smartphone 110.

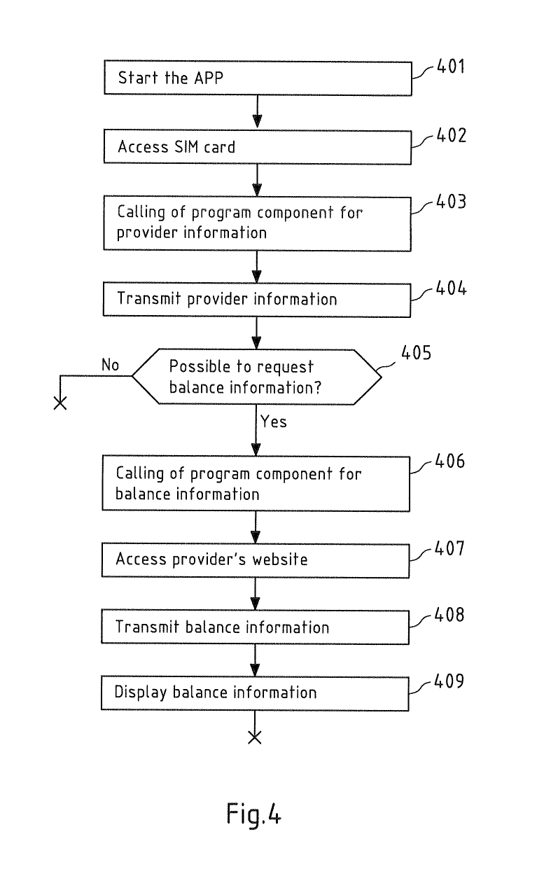

FIG. 4 shows a schematic flow diagram which illustrates an embodiment of an inventive method according to the second aspect of the invention and an embodiment of an inventive method according to the fourth aspect of the invention in the context of the environment illustrated in FIG. 1.

A user of the smartphone 110 starts the app 114 in step 401.

The app 114 comprises program code for accessing the SIM card 117 to ascertain with which provider the SIM card 117 is associated if the program code is executed on the processor 111. A provider identifier is read from the SIM card 117 for this purpose. This operation is executed in step 402.

In step 403 the app 114 calls program component 136 of the computer program 134 via the interface 138 of the computer program 134. The program component 136 is designated by ‘getAvailableProvider’ within the framework of the embodiment discussed here.

For the case of a SOAP-based web service the call can be structured as follows:

```
<soapnv:Enverlope
xmlns:soapnv=http://schemas.xmlsoap.org/soap/envelope/”
Xsmlns:ser=”http://service.prelado.peachesgroup.com
  <soapenv:Header/>
  <soapenv:Body>
  <ser:getAvailableProvider>
    <credentials>
    <customerId>id</customerId>
    <password>pass</password>
    </credentials>
  </ser:getAvailableProvider>
  </soapenv:Body>
</soapenv:Envelope>
```

For the case of a REST-based web service the call can be directed for example via POST command to the URL

```
      /rest/balance/availableProvider/get
and be structured as follows:
{
    “customerId”:”id”,
    “password”:”pass”
}
```

The parameters “customerId” and “password” are both of the ‘string’ data type within the framework of the embodiment discussed here. It is obligatory that they are transferred to the interface 138 of the computer program 134.

In response to a proper calling of the program component 136 via the interface 138 the program component 136 generates a reply which contains provider information relating to providers which allow transmission of information relating to a balance available to a user of a telecommunications terminal by a server at the causing of the program component 135.

The program component 136 provides in step 404 for the transmission of the provider information to the app 114 running on the smartphone 110. The transmission can occur via the Internet 140. It is also conceivable, however, for the provider information to be transmitted in some other way, for example via SMS, using the network infrastructure 180.

In step 404 the server 130, specifically the computer program 134, more precisely the program component 136, logs the fact that it has been contacted via the app 114 in order to cause the transmission of provider information. For this purpose the program component 136 forwards the access data transferred to the interface 138 to a server of the provider 190, so that for billing it is known who has requested the provider information.

For the case of a SOAP-based web service a message designated here by ‘getAvailableProviderResponse’, with which the provider information is transmitted, can be structured as follows:

```
  <soap:Envelope
  xmlns:soap=”http://schemas.xmlsoap.org/soap/envelope/”>
    <soap:Body>
      <ns2:getAvailableProviderResponse
  xmlns:ns2=”http://service.prelado.peachesgroup.com/”>
        <result>
  <message>success</message>
  <providerList>
    <provider>
      <id>DISCOTEL</id>
      <loginMethod>MSISDN</loginMethod>
      <name>discoTEL</name>
      <status>ONLINE</status>
  <registrationURL>http://provider.de/registration</registration
  URL>
    </provider>
    <provider>
      <id>SIMYO</id>
      <loginMETHOD>MSISDN</loginMethod>
      <name>simyo</name>
      <status>ONLINE</status>
<registrationURL>http://provider.de/registration</registration
URL>
  </provider>
```

For the case of a REST-based web service the message, with which the provider information is transmitted, can be structured as follows:

```
{
  “message”:”success”
  “providerList”: [ { “provider”: [
      {
    “id”:”DISCOTEL”,
    “loginMethod”: “MSISDN”,
    “name”: ”discoTEL”,
    “status”: ”ONLINE”,
    “registrationURL”, http://provider.de/registration
    },
      {
    “id”:”SIMYO”,
    “loginMethod”: “MSISDN”,
    “name”: “simyo”,
    “status”: “ONLINE”,
    “registrationURL”, http://provider.de/registration
    }
  ]}],
  “resultCode”: 0
}
```

The parameter “id” is of the ‘string’ data type within the framework of the embodiment discussed here. It designates a unique provider identification.

The parameter “name” is also of the ‘string’ data type. It specifies which provider name should be displayed within the framework of a possible visual display of provider information.

The parameter ‘status’ is of the ‘enum’ data type and can assumes the three different values ‘ONLINE’, ‘DISABLED’ and ‘OFFLINE’. ‘ONLINE’ means that it is currently possible to request balance information for the provider designated by the parameters ‘id’ and ‘name’. ‘DISABLED’indicates that it is not currently possible to request balance information for the provider due to maintenance. ‘OFFLINE’ means that requesting of balance information is not provided for the provider.

The parameter ‘loginMethod’ is also of the ‘enum’ data type and can assume the two different values ‘MSISDN’ and ‘LOGIN_NAME’. ‘MSISDN’ means that to request balance information using the program component 135, access data has to be transferred to the interface 137 for identification of a user or a telecommunications terminal, wherein the access data must contain a MSISDN associated with the telecommunications terminal. ‘LOGIN_NAME’ means that the access data for identification must contain a user name.

The parameter ‘registrationURL’ is of the ‘string’ data type. It designates a URL under which registration for use of the request for balance information by means of the program component 135 can be performed with the respective provider.

In step 405 the app 114 checks whether it is possible for the provider, which has been ascertained in step 402 as being associated with the SIM card 117, to request balance information by means of the program component 135 according to the provider information previously transmitted and accordingly received. The method ends at this point if this is not the case. Otherwise the method continues with step 406.

Steps 402 to 405 can be omitted if the app 114 had already been started before and steps 402 to 405 have been run through, so the app 114 has already received suitable information about the provider 190.

If a registration for requesting information relating to a balance associated with the SIM card 117 has not yet been made of the provider 190 this registration is firstly undertaken under the URL valid for the provider 190 according to the provider information.

Step 406 also comprises the app 114 generating a message which is sent to the server 130 via the Internet 140. The message contains a calling of the program component 135 via the interface 137. The message also includes access data whose content is directed toward the provider information transmitted in step 404, so that, for example, the login information specified in relation to the provider 190 according to the parameter ‘loginMethod’ is contained in the access data. The identity of the provider 190 is also given in the access data in accordance with the convention imparted with the provider information (parameter ‘id’).

The message of the app 114 to the server 130 is designated by ‘getBalance’ within the framework of the embodiment discussed here.

For the case of a SOAP-based web service the message may be structured as follows:

```
<soapenv:Envelope
xmlns:soapenv=”http://schemas.xmlsoap.org/soap/envelope/”
Xmlns:ser=”http://service.prelado.peachesgroup.com/”>
  <soapenv:Header/>
  <soapenv:Body>
    <ser:getBalance>
      <credentials>
        <customerId>id</customerId>
        <password>pass</password>
      </credentials>
      <request>
        <msisdn>+4917777777777</msisdn>
        <loginName></loginName>
        <password>pass</password>
        <id>DISCOTEL</id>
      </request>
    </ser:getBalance>
    </soapenv:Body>
  </soapenv:Envelope>
```

For the case of a REST-based web service the message may be structured as follows, wherein it can be directed via a GET command to the URL

```
/rest/balance/get
{
    “credentials”:{
        “customerId”: “id”,
        “password”: “pass”
    }
    “request”:{
        “msisdn”: “+4917777777777”,
        “loginName”: “”,
        “password”: “pass”,
        “id”: “DISCOTEL”
    }
}
```

The parameter ‘msisdn’ is of the ‘string’ data type. It must be contained in the message and designates the MSISDN of the smartphone 110.

The parameter ‘loginNAME’ is also of the ‘string’ data type. It is only required if the provider 190 anticipates a login by means of a user name for access to the balance information. In the embodiment illustrated here this is not the case for the provider 190 since an MSISDN is anticipated instead of a user name.

The parameter ‘password’ is also of the ‘string’ data type. It must be included in the access data.

The parameter ‘id’ designates the identity of the provider 190 and is also of the ‘string’ data type.

Once the server 130 has received the message from the app 114 it analyses it. The computer program 134 recognises that it contains a calling of the program component 135 via the interface 137. The program component 135 is therefore called via the interface 137, wherein parameters contained in the message of the app 114, in particular the access data, are transferred to the interface 137.

The website 151 comprises inter alia a web page 152 on which a user can register using a browser with a login name and a password as access data. Following successful verification of the access data the user arrives at a different web page 152. This shows the user the information relating to the balance associated with the SIM card 117, for example the balance amount and the date of the last balance top-up. The content of this web page 152 is transmitted via the Internet to a device from which the user called the web page 152. This may be the smartphone 110 or the PC 120 by way of example. The balance information is stored in the database 170. This is accessible for the server 160. The database 170 can either be hosted by the server 160 for this purpose or it can be stored on a different computer which the server 160 can access.

In step 407 the program component 135 automatically initiates and controls access to the website 151 of the provider 190. It uses the access data previously transmitted to it by the app 114 to be able to automatically carry out the login process. The provider identity is required in order that the correct website 151 is selected. The web page 152 generated by the web server 150 after the successful login process, and which contains the balance information, is automatically processed by the program component 135 of the computer program 134. The balance amount is read from the website 152.

In step 407 the web server 150 also logs that balance information has been requested via the web service implemented by the computer program 134. For this purpose the access data transferred to the interface 137 and forwarded to the web server 150 is recorded, so that it is known for the purpose of invoicing who requested the balance information.

In step 408 the program component 135 ensures that the extracted balance amount is transmitted from the server 130 to the smartphone 110, specifically to the app 114. A message designated here by ‘getBalanceResponse’ is generated and transmitted for this purpose.

For the case of a SOAP-based web service this message can be structured as follows:

```
<soap:Envelope
xmlns:soap=”http://schemas.xmlsoap.org/soap/envelope/”>
  <soap:Body
    <ns2:getBalanceResponse
xmlns:ns2=”http://service.prelado.peachesgroup.com/”>
      <result>
        <balance>12.50</balance>
        <message>success</message>
        <resultCode>0</resultCode>
      </result>
    </ns2:getBalanceResponse>
  </soap:Body>
</soap:Envelope>
```

For the case of a REST-based web service this message can be structured as follows:

```
{
  “balance”: 12.50,
  “message”: “success”,
  “resultCode”: 0
}
```

The parameter ‘balance’ is of the ‘double’ data type. It designates the amount of the balance associated with the SIM card 117.

The parameter ‘message’ is of the ‘string’ data type. In addition to the balance amount it can be used to transmit a text message which can be displayed to provide the user with additional information.

The parameter ‘resultCode’ is of the ‘integer’ data type. It can assume seven different numerical values from 0 to 6. 0 indicates successful retrieval of balance information from the website 151; 1 means that the access data was not correct and its verification has therefore failed; 2 means that the MSISDN given in the access data or the given user name is not known to the website 151 of the provider 190; 3 indicates that the program component 135 does not recognise the provider identity given in the access data; 4 indicates that the provider 190 is currently ‘OFFLINE’, i.e. that requesting of balance information is not currently provided for the provider 190; 5 points to a system error; 6 indicates that the provider 119 is currently in the ‘DISABLED’ status in relation to the requesting of balance information, i.e. that it is not currently possible to request balance information due to maintenance.

The app 114 takes the balance information from the message transmitted in step 408, i.e. the value of the parameter ‘balance’ and in step 409 controls the touchscreen 119 by means of the processor 111, so that the balance information is displayed on it.

Since the program component 135 evaluates the message sent by the app 114 in step 406, the access data contained in this message has been created on the basis of the provider information transmitted in step 404, and the program component 135 uses the access data within the framework of access to the website 151 in step 407, the program component 135 is configured to cause transmission of the balance information in step 408 in a manner tailored to the provider 490.

Both the program component 135 and the program component 136 are configured to store the access data transmitted to them via the interfaces 137 and 138 only transiently. Once the access data has been forwarded to the web server 150 or to the provider 190 no copy of the access data remains in the program components 135 or 136. It is deleted by the program components 135 and 136 immediately after forwarding. The web service implemented by the computer program 134 can therefore be used without data protection or security concerns.

Since the operating system 115 of the smartphone 110 is iOS it is not possible to initiate a request for balance information by means of a USSD command. The operating system 115 prevents this. By using the web service implemented by the computer program 134 the user of the smartphone 110 can still conveniently arrive at balance information by means of the app 114. Starting of the app 114 can even be enough as a single action by the user for him to be supplied with balance information. The user is spared from having to acquire balance information by making a call to the provider 190 or by manually calling the website 151 and inputting his access data there.

Balance or provider information can not only be requested by means of the app 114 of the smartphone 110. It can also be undertaken via the PC 120. For this purpose a computer program similar to the app 114 is installed on the PC 120. A fundamental difference from the app 114 is merely that the computer program demands a user specification for the identity of the provider 190 since it cannot access the SIM card 117 to determine the identity of the provider 190.

1. Computer readable medium having a computer program stored thereon, wherein the computer program is configured to implement a web service, wherein the computer program has an interface via which a program component is callable, wherein the program component is configured to cause transmission of information relating to a balance available to a user of a telecommunications terminal by a server, wherein transmission of the information is additionally causable via a website, and wherein the program component is configured to access the website to cause the transmission of the information.

2. Computer readable medium according to claim 1, wherein the information is transmitted to an apparatus from which a calling of the program component has been issued via the interface.

3. Computer readable medium according to claim 1, wherein access data are transferable to the program component via the interface.

4. Computer readable medium according to claim 3, wherein the program component is configured to store the access data only transiently.

5. Computer readable medium according to claim 1, wherein
the balance is useable for using a chargeable service of a provider by means of the telecommunications terminal, and wherein
the program component is configured to cause the transmission of information in a manner tailored to the provider.

6. Computer readable medium according to claim 1, wherein a further program component of the computer program is callable via a further interface of the computer program, wherein the further program component is configured to cause the transmission of provider information relating to providers which allows transmission of information relating to a balance available to a user of a telecommunications terminal by a server at the causing of the program component.

7. Computer readable medium according to claim 1, wherein an identification module is assigned to the telecommunication terminal, which is associated with a provider which provides a chargeable service, for the use of which by means of the telecommunication terminal the balance is useable.

8. Computer readable medium according to claim 1, wherein the server is configured to log an access.

9. Method comprising:
causing transmission of information relating to a balance available to a user of a telecommunications terminal by a server, wherein the causing occurs by a program component of a computer program, wherein the computer program is configured to implement a web service, and the computer program has an interface via which the program component is callable, wherein transmission of the information is additionally causable via a website, and wherein the program component is configured to access the website to cause the transmission of the information.

10. Computer readable medium having a computer programstored thereon, wherein the computer program is configured to call a program component of a computer program which is configured to implement a web service via an interface of the computer program, wherein the program component is configured to cause transmission of information relating to a balance available to a user of a telecommunications terminal by a server, wherein transmission of the information is additionally causable via a website, and wherein the program component is configured to access the website to cause the transmission of the information.

11. Method comprising:
calling a program component of a computer program which is configured to implement a web service via an interface of the computer program, wherein the program component is configured to cause transmission of information relating to a balance available to a user of a telecommunications terminal by a server, wherein transmission of the information is additionally causable via a website, and wherein the program component is configured to access the website to cause the transmission of the information.

12. Apparatus comprising at least one processor and at least one memory, which contains computer program code, wherein the at least one memory and the computer program code are configured, together with the at least one processor, to cause an apparatus to cause transmission of information relating to a balance available to a user of a telecommunications terminal by a server, wherein the causing occurs by a program component of a computer program, wherein the computer program is configured to implement a web service, and the computer program has an interface via which the program component is callable, wherein transmission of the information is additionally causable via a website, and wherein the program component is configured to access the website to cause the transmission of the information.

13. Apparatus comprising at least one processor and at least one memory, which contains computer program code, wherein the at least one memory and the computer program code are configured, together with the at least one processor, to cause an apparatus to call a program component of a computer program which is configured to implement a web service via an interface of the computer program, wherein the program component is configured to cause transmission of information relating to a balance available to a user of a telecommunications terminal by a server, wherein transmission of the information is additionally causable via a website, and wherein the program component is configured to access the website to cause the transmission of the information.
